(19) United States
(12) Patent Application Publication
(10) Pub. No.: US 2026/0231278 A1
(43) Pub. Date: Aug. 6, 2026

(54) COMMUNICATIONS DEVICES, INFRASTRUCTURE EQUIPMENT AND METHODS

(71) Applicant: Sony Group Corporation, Tokyo (JP)

(72) Inventors: Yassin Aden AWAD, Basingstoke (GB); Vivek SHARMA, Basingstoke (GB); Yuxin WEI, Basingstoke (GB); Hideji WAKABAYASHI, Basingstoke (GB)

(73) Assignee: Sony Group Corporation, Tokyo (JP)

(21) Appl. No.: 19/153,143

(22) PCT Filed: Feb. 7, 2024
(86) PCT No.: PCT/EP2024/053025

§ 371 Date: Aug. 1, 2025

(30) Foreign Application Priority Data
Feb. 10, 2023 (EP) 23156151.5

(51) Int. Cl. H04W 76/27; H04W 74/0833; H04W 76/28

(52) U.S. Cl. CPC H04W 76/27; H04W 74/0833; H04W 76/28

(57) ABSTRACT

A communications device and method of transmitting data via a wireless communications network are provided. The method includes configuring transceiver circuitry to transition to a Radio Resource Control (RRC) Inactive state with established communications resources. The device receives an indication of an Off-state of a discontinuous reception (DRX) cycle of infrastructure equipment and determines that it has data to transmit. The device adapts its transmission based on the received indication, such as refraining from transmitting uplink data during the Off-state. The data may be transmitted using configured grant resources or as part of a Small Data Transmission (SDT) protocol. In some examples, the method includes performing a random access procedure for transmitting data. A failure detection timer may be started to monitor completion of the transmission, and the device may further adapt the transmission or the timer based on the Off-state duration.

### BACKGROUND

### Field

The present disclosure relates to communications devices, infrastructure equipment of a wireless communications network and methods of operating communications devices to transmit uplink data and infrastructure equipment of a wireless communications network to receive uplink data from communications devices when in an RRC inactive state. The present disclosure claims the Paris convention priority of European patent application number EP23156151.5 filed on 10 Feb. 2023 the contents of which are incorporated herein in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

3GPP defined wireless communications systems are able to support more sophisticated services than simple voice and messaging services offered by previous generations of mobile telecommunication systems. UMTS and Long Term Evolution (LTE) systems are able to support high data rate applications such as mobile video streaming and mobile video conferencing that is comparable with a fixed line data connection. The demand to deploy such networks is therefore strong and the coverage area of these networks, i.e., geographic locations where access to the networks is possible, may be expected to increase ever more rapidly.

With further developments, wireless communications networks can support a wider range of devices associated with a wider range of data traffic profiles and types. For example, it is expected that future wireless communications networks will be expected to support efficiently communications with an increasing range of devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

Wireless communications networks, for example those which may be referred to as 5G or new radio (NR) system/new radio access technology (RAT) systems [1], as well as future iterations/releases of existing systems, can support connectivity for an increased diversity of devices associated with different applications and different characteristic data traffic profiles. One such application is to provide a facility for low power and low complexity devices to support transmissions of small amounts of data, in which communications devices support small data transmissions in a Radio Resource Control (RRC) Inactive state. However, such techniques may present new challenges when combined with other network adaptations.

### SUMMARY

The present disclosure can help address or mitigate at least some of the issues discussed above. Various aspects and features of the present technique are defined in the appended claims.

Example embodiments can provide a communications device (UE) or a method of transmitting data by a communications device (UE) via a wireless communications network. The method comprises configuring transceiver circuitry of the communications device to transition to a Radio Resource Control (RRC) Inactive state, in which the communications device has established communications resources of a wireless access interface for transmitting or receiving data. The method further comprises receiving an indication of an Off-state of a discontinuous reception (DRX) cycle of an infrastructure equipment of the wireless communications network. For example, the Off-state may be a state in which a receiver of the infrastructure equipment is in a reduced power state and cannot receive signals with sufficient power transmitted by the communications device according to the DRX cycle, which includes an ON-state in which the receiver of the infrastructure equipment is powered and can receive data from the communications device. The method comprises determining that the communications device has data to transmit to the infrastructure equipment, and transmitting the data to the infrastructure equipment in accordance with the received indication. The communications device may adapt the transmission of the data by not transmitting the uplink data during the Off-state. The established communications resources may be configured grant resources.

Example embodiments can also provide a method of operating a communications device. Embodiments can also provide a communications device (UE) or a method of transmitting or receiving data by a communications device (UE) via a wireless communications network, which comprises configuring transceiver circuitry of the communications device to transition to a Radio Resource Control, RRC, Inactive state, in which the communications device has established communication with an infrastructure equipment of the wireless medications network for transmitting or receiving data. The established communication may include synchronising the transceiver circuitry of the communications device to a wireless access interface provided by an infrastructure equipment of the wireless indications network, so that in the RRC inactive state the communications device can transmit signals to the infrastructure equipment without having to transition to an RRC connected state. The method further comprises receiving an indication of an Off-state of a DRX cycle of the infrastructure equipment. The Off-state may be a reduced power state according to the DRX, cycle, which includes an ON-state in which the receiver of the infrastructure equipment is powered and can receive data from the communications device. The method comprises transmitting a random access preamble to an infrastructure equipment of the wireless communications network as part of a random access procedure for transmitting data to the wireless communications network, receiving a message from the infrastructure equipment in response to the random access preamble as part of the random access procedure, and transmitting data to the infrastructure equipment as part of or after completing the random access procedure. The method further comprises starting a failure detection timer for detecting whether the transmission of the data to the infrastructure equipment has been completed within a transmission failure time, and adapting the transmission of the data in accordance with the received indication of the Off-state. The communications device may adapt the transmission by not transmitting the uplink data during the Off-state and/or the transmission failure timer in accordance with a duration of the Off-state.

Embodiments can also provide embodiments can also include an infrastructure equipment and a method of receiving data from a communications device by an infrastructure forming part of a wireless communications network. The method comprises configuring a communications device to transition to an Radio Resource Control (RRC) Inactive state, in which the communications device is configured with a grant of resources for the communications device to transmit uplink data to the infrastructure equipment, transmitting an indication of an Off-state of a DRX cycle to the communications device. The Off-state may be a state in which a receiver of the infrastructure equipment is in a reduced power state and may not be able to receive signals transmitted by the communications device according to the DRX, cycle, which includes an ON-state in which the receiver of the infrastructure equipment is powered and can receive data from the communications device. The configuring the communications device to transmit the uplink data includes configuring the communications device to transmit the uplink data during the On-state and to suspend transmission of the uplink data during the Off-state.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system, which may be configured to operate in accordance with certain embodiments of the present disclosure;

FIG. 2 schematically represents some aspects of a new radio access technology (RAT) wireless telecommunications system, which may be configured to operate in accordance with certain embodiments of the present disclosure;

FIG. 3 is a schematic block diagram of an example of an infrastructure equipment and a communications device in more detail and illustrating a transition of the communications device between RRC states in accordance with example embodiments;

FIG. 4A is an illustrative message flow diagram between an infrastructure equipment and a communications device (UE) illustrating a 4-step random access procedure; and FIG. 4B is an illustrative message flow diagram between an infrastructure equipment and a communications device (UE) illustrating a 2-step random access procedure;

FIG. 5 is a graphical representation of a discontinuous reception (DRX) cycle of an infrastructure equipment including an On-state when it is able to receive signals from communications devices (UEs) and an Off-state when it is not able to receive signals from communications devices which is presented on a common time axis with configured grant resources;

FIG. 6 is a representative flow diagram illustrating example processes performed by an infrastructure equipment and a communications device in accordance with example embodiments in which the communications device is configured to adapt transmission of uplink data in accordance with an off state of the infrastructure equipment; and

FIG. 7 is a representative flow diagram illustrating example processes performed by an infrastructure equipment and a communications device in accordance with example embodiments in which the communications device is configured to adapt transmission of uplink data in accordance with a random access procedure.

### DETAILED DESCRIPTION OF THE EMBODIMENTS

### Long Term Evolution Advanced Radio Access Technology (4G)

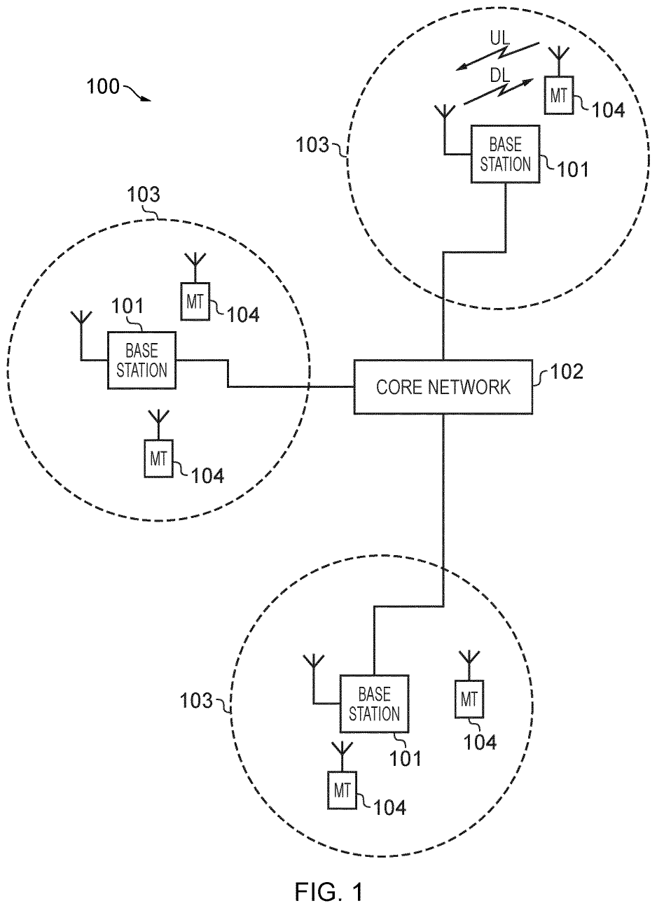

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs, g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

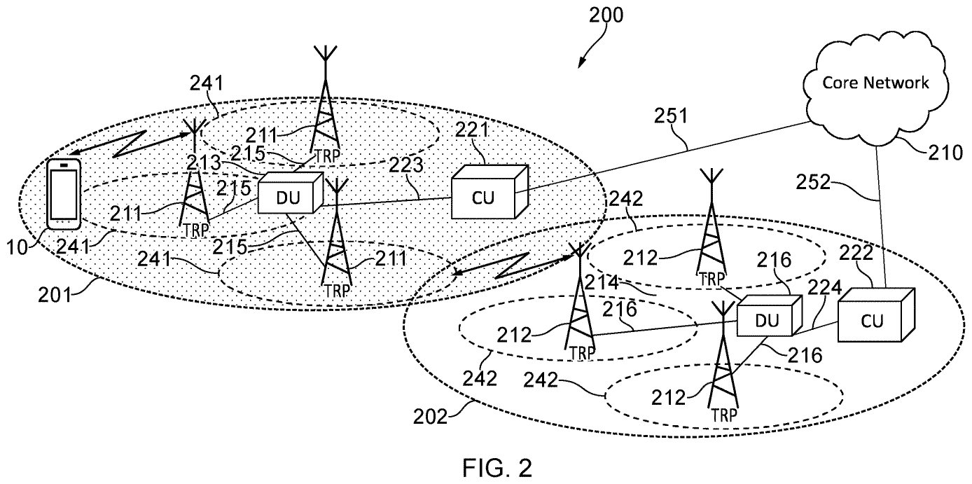

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated that in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus, example embodiments of the disclosure as discussed herein may be implemented in wireless telecommunication systems/networks according to various different architectures, such as the example architectures shown in FIGS. 1 and 2. It will thus be appreciated that the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

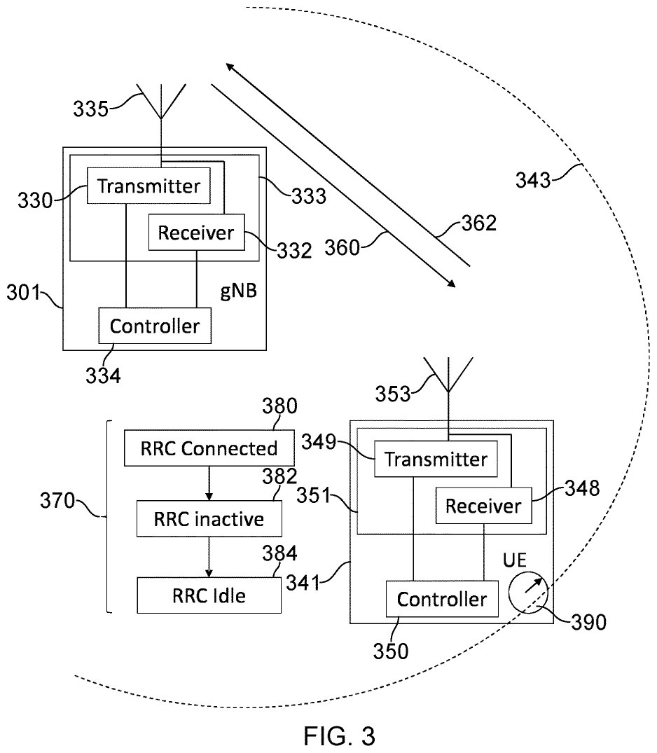

In a 5G network, a CU 221 in combination with one or more DUs 213, 216 and one or more TRPs 211, 212 can form a base station or gNB 301 of a radio network part of the 5G radio access network (RAN). In FIG. 3, a gNB 301, formed from one or more TRPs 211, 212, one or more DUs 213, 216 and CU 221 can be represented in a simplified form as comprising, transmitter circuitry 330, receiver circuitry 332, an antenna 335 and a controller circuit or controlling processor 334 which may operate to control the transmitter 330 and the wireless receiver 332 to transmit and receive radio signals to one or more UEs 341 within a cell 343. The transmitter circuit 330 and the receiver circuit 332 may be implemented together to form a wireless transceiver 333. As shown in FIG. 3, an example UE 341 is shown to include corresponding receiver circuitry 348, transmitter circuitry 349, an antenna and controller circuitry 350. The transmitter circuit 349 and the receiver circuit 348 may be implemented together to form a wireless transceiver 351. The controller circuitry 350 is configured to control the transmitter circuitry 349 to transmit signals representing uplink data to the wireless communications network via the wireless access interface formed by the gNB 301 as represented by an arrow 362. The controller circuitry 350 is also configured to control the receiver circuitry 348 to receive downlink data as signals transmitted by the transmitter 330 represented by an arrow 362 and received by the receiver 348 in accordance with the conventional operation.

The transmitter circuits 330, 349 and the receiver circuits 332, 348 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controller circuits 334, 350 (as well as other controllers described in relation to examples and embodiments of the present disclosure) may be, for example, a microprocessor, a CPU, or a dedicated chipset, etc., configured to carry out instructions, which are stored on a computer readable medium, such as a non-volatile memory. The processing steps described herein may be carried out by, for example, a microprocessor in conjunction with a random access memory, operating according to instructions stored on a computer readable medium.

The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

Also shown in FIG. 3 UE 341 may be configured to transition between different Radio Resource Control (RRC) states 370, which include an RRC Connected state 380, and RRC Idle state 382 and an RRC Inactive state 384. The UE 330 may transmission between these states in accordance with the mode of operation depending on whether it has been allocated a bearer for transmitting or receiving data (RRC Connected state), whether it is in a state where it is not transmitting or receiving data (RRC Idle state) or maybe configured on demand to transmit small amounts of data (RRC Inactive). In an RRC Connected state 380 the UE 341 establishes a connection with the wireless communications network to transmit and/or receive data via the gNB 301. In an RRC Inactive state 382 resources are allocated for the UE 341 but the UE 341 does not have an active connection for transmitting and receiving data across the wireless indications network. In an RRC Idle state 384. As will be explained in following paragraphs, the UE 341 may be configured in an RRC Inactive state 382 to transmit and/or receive small amounts of data (small data transmissions (SDT)), for example via configured grant (CG) resources or using a random access procedure. An RRC Connected state is known in 3GPP standards such as LTE and 5G/NR to be a state in which a UE has established various protocols and connections in order to transmit or receive data by the wireless communications network. In this RRC Connected state, the UE has established a context with the wireless communications network and various tunnels for transmitting data both via a wireless access interface and also across the wireless indications network. In this state handover is controlled by the wireless communications network based on measurements reported by the UE. Once the communication has finished and the UE has transmitted or receive data according to the service being supported, the connection is terminated either by the wireless communications network or by the UE. Upon termination of the connection, the UE enters an RRC Idle state in which the various tunnels by the wireless indications network are torn down and the UE moves to a state in which it selects the point of the wireless communication to attach. With the introduction of 5G/NR, a further state of the RRC Inactive state was introduced, in which after establishing various protocols and a context for communicating data via wireless indications network in an RRC ACTIVE state, the UE enters an RRC Inactive state in which these tunnels are maintained and protocols are suspended even though the UE is not transmitting or receiving data. Setting up communications tunnels and protocols for transmitting and receiving data via the wireless communications network represents a considerable amount of signalling. By introducing an RRC Inactive state, signalling is very much reduced, and energy expended by the UE is reduced so that once a UE has data to transmit or the wireless communications network has data to transmit data to the UE, then using a signalling message the UE can transmission more quickly to an RRC Connected state to transmit and to receive data. As will be explained in the following paragraphs, an RRC Inactive state can be used by the UE to transmit small amounts of data (SDT). In the RRC Inactive state, the UE can conserve energy and quickly moved to transmit data, which is particularly applicable to SDT. A condition for a UE transitioning to an RRC Inactive state is that the UE remains within the cell and maintains synchronisation with a wireless access interface provided by the cell.

As will be explained shortly, a SDT failure detection timer 319a is also used to control the communication of uplink data for SDT, which can be used to supervise SDT transmissions when data is transmitted using a random access procedure (RA-SDT) or CG resources (CG-SDT).

### Small Data Transmissions (SDTs)

Release 17 of the 3GPP standards includes provision for supporting small data transmissions (SDT) in the uplink while a transmitting UE is in the RRC Inactive state as well as Multicast and Broadcast Services (MBS) and positioning enhancements. With reference to [6], some specific examples of mobile originated small data transmission (MO SDT) and infrequent data traffic may include the following use cases:
Smartphone applications;
Traffic from Instant Messaging services;
Heart-beat/keep-alive traffic from IM/email clients and other applications; and

Push notifications from various applications;
Non-smartphone applications;

Traffic from wearable devices (e.g. periodic positioning information);
Sensors (e.g., Industrial Wireless Sensor Networks transmitting temperature or pressure readings, periodically or in an event-triggered manner); and
Smart meters and smart meter networks sending periodic meter readings.

Uplink small data transmissions have been enabled for UEs in the RRC Inactive state in order to reduce the signalling overheads as well as power consumption at the UE, and primarily being for infrequent data traffic. SDT on the uplink for UEs in the RRC_Inactive state has been agreed for both RACH based schemes (i.e., 2-step and 4-step RACH)-known as Random Access SDT (RA-SDT)—and configured grant (CG) based schemes (CG-SDT), each of which is discussed in greater detail below. This includes general procedures to enable user plane data transmissions for small data packets on the uplink in the inactive state (for example using either message A of the 2-step RACH procedure or message 3 of the 4-step RACH procedure), and enables flexible payload sizes larger than the Release 16 Common Control Channel (CCCH) message size that is possible currently for a UE in the RRC_Inactive state to transmit small data in message A or message 3 to support user plane data transmission in the uplink.

Three schemes have been agreed by 3GPP for the initiation of SDT on the uplink, originating from a mobile UE in the inactive state. These are:
4-step RACH based scheme;
2-step RACH based scheme; and
CG based scheme.

### 4-Step RACH Scheme

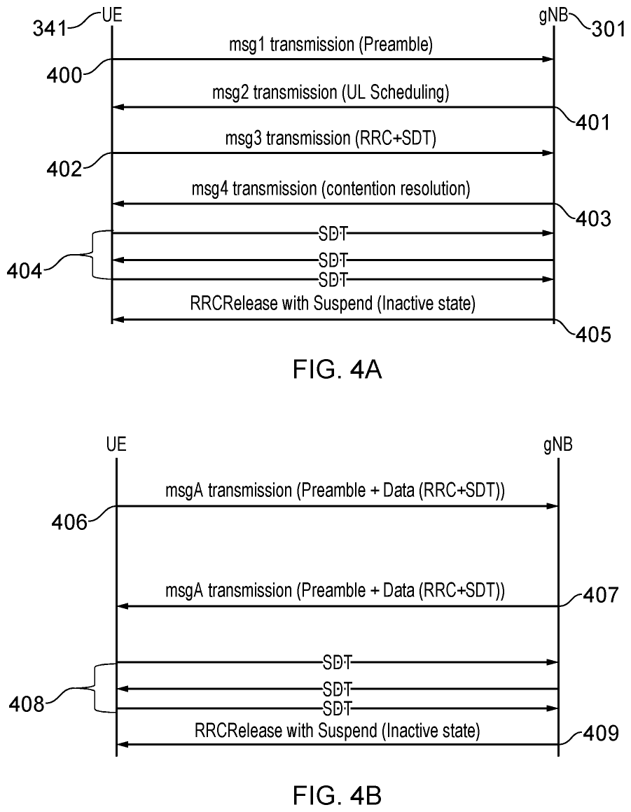

FIG. 4A shows an example of the 4-step RACH based scheme, and shows how MO SDTs can be initiated by such a scheme. When a UE has an UL SDT ready for transmission, it may start a 4-step RACH procedure as shown in FIG. 4A, which comprises the following steps:
A UE starts message 1 transmission 400 of a Physical Random Access (PRACH) preamble from a set of preambles allocated for SDT in the current cell. When a gNB receives the preambles, it identifies this as an SDT initiation, and responds with message 2.
The gNB transmits 401 message 2, which contains UL timing alignment command and UL PUSCH scheduling for message 3.
The UE transmits 402 message 3, which contains Radio Resource Control (RRC) signaling. For example, the UE may transmit an RRC Resume Request. If there is any remaining space in message 3, the UE may also transmit SDT data in message 3. As will be explained in more detail below, the transmission of message 3 may trigger an SDT failure timer at the UE defining a period for which the UE can communicate SDTs with the gNB.
Similarly to the general 4-step RACH procedure, the gNB then provides 53 the contention resolution after the UE that transmitted the preamble in the first step 400 is identified and confirmed. In this step 403, DL and UL feedback or acknowledgments are transmitted.
For UL feedback received by a gNB from a UE in response to transmitting a DL PDSCH to that UE, a HARQ-ACK is transmitted on a cell-specific PUCCH resource configured within the system information (though it should be noted that, that from the third step 402, the UE is already UL-synchronised).
For DL feedback received by a UE in response to transmitting the UL message 3 in the third step 402, the reception of message 4 in the fourth step 403 at the UE is considered as a positive acknowledgment.
After the fourth step 403, the UE is now already identified by the network and is also UL-synchronised. Hence, subsequent UL and DL SDT with dynamic scheduling can take place 404 as required while the UE remains in the Inactive state. Once SDT is completed, and neither the gNB or UE have any further small data to transmit, the gNB can choose to keep the UE in RRC_Inactive state by sending RRCRelease with suspend indication 405.

### 2-Step RACH Scheme

FIG. 4B shows an example of the 2-step RACH based scheme, and shows how MO SDTs can be initiated by such a scheme. When a UE has an UL SDT ready for transmission, it may start a 2-step RACH procedure as shown in FIG. 4B, which comprises the following steps:
A UE starts message A transmission 406 of a PRACH preamble and associated PUSCH for SDT in the current cell. The PUSCH contains RRC signaling. For example, message A (i.e., RRCResumeRequest). If there is any remaining space in the PUSCH, the UE may transmit SDT data. As will be explained in more detail below, the transmission of message A may trigger an SDT failure timer at the UE defining a period for which the UE can communicate SDTs with the gNB.
When the gNB receives 406 message A, it responds 407 with message B which contains both an UL timing alignment command and the contention resolution where the UE which transmitted 406 message A in the first step is identified and confirmed. In this step 407, DL and UL feedback or acknowledgments are transmitted.
For UL feedback received by a gNB from a UE in response to a DL PDSCH being transmitted by the gNB to that UE, a HARQ-ACK is transmitted by the UE on a cell-specific PUCCH resource configured within the system information.
For DL feedback received by a UE from the gNB in response to message A being transmitted 406 by that UE, the reception 407 of message B at the UE is considered as a positive acknowledgment; and
After the second step 407, the UE is now already identified by the network and is also UL-synchronised. Hence, subsequent UL and DL SDT with dynamic scheduling can take place 404 as required while the UE remains in the RRC_Inactive state. Once SDT is completed, and neither the gNB or UE have any further small data to transmit, the gNB can choose to keep the UE in RRC Inactive state by sending RRCRelease with suspend indication 409.

### Configured Grant (CG) Scheme

When a UE remains in the same coverage area or cell for a period of time, it is possible that the UE can use some pre-configured UL resources for transmitting data, provided that the UE is UL synchronised, while remaining in the RRC_Inactive state. Hence in Release 17 of the 3GPP standards, it has been agreed that a network can configure dedicated CG PUSCH resource(s) for SDT on an initial BWP, just before a UE moves to the RRC_Inactive state.

The first message of CG contains RRC signalling. For example, the first message of CG may include an RRCResumeRequest. If there is remaining space in the first message of CG, the UE may include SDT data in the first message of CG. As will be explained in more detail below, the first message of CG may trigger an SDT failure timer at the UE defining a period for which the UE can communicate SDTs with the gNB.

### Small Data Transmission (SDT) Failure Timer

As mentioned above, the transmission of message A or message 3 may trigger the commencement of an SDT failure timer at the UE. In some cases, the SDT failure timer may be triggered by the transmission of the first uplink transmission, which can deliver SDT data. In such cases, the transmission of message A or message 3 may trigger the SDT failure timer even if those messages do not actually include any SDT data because, for example, there is insufficient space in the message for the SDT data. In some cases, the SDT failure timer may be triggered by the first actual transmission of SDT data. In such cases, the first SDT transmission in step 404 or step 408 may trigger the SDT failure timer. If message A or message 3 actually contain SDT data, then those messages would trigger the SDT failure timer. The message which triggers the SDT failure timer may be referred to as an “SDT initiation signal”. The message A may comprise at least a RRCResumeRequest or RRCResumeRequest1 when the resume procedure is initiated for SDT. Alternatively, the message 3 may comprise at least a RRCResumeRequest or RRCResumeRequest1 when the resume procedure is initiated for SDT.

If the UE does not receive any grant scheduling (for example, either DL PDSCH or UL PUSCH) from the gNB before the SDT failure timer expires, the UE may assume that SDT has failed. In some cases, the UE may transition to an idle state (such as the RRC_IDLE state) on expiry of the SDT failure timer. In other words, the SDT failure timer sets a time period during which the UE can communicate SDTs with the gNB. The time for which the UE can communicate SDTs with the gNB may also be referred to as an “SDT Session”.

In the examples shown in FIGS. 4A and 4B, the RRCRelease with Suspend Message 408, 409 is transmitted from the gNB to the UE before the expiry of the SDT failure timer so as to prevent the UE from transitioning to the RRC_IDLE state by instructing the UE to remain in the RRC_Inactive STATE.

There are two options (Opt 1 and Opt 2) under discussion for the implementation of the SDT failure timer:

The SDT failure timer is started at the beginning of the SDT session only. For example, with reference to FIGS. 4A and 4B, the SDT failure timer is started only on transmission of message 3 or message A and is not subsequently restarted.

### Network Energy Saving (NES)

In Release-18 of the 3PP standards, a new study item has been initiated on Network Energy Saving (NES) ([4]). The objectives of the study item are the following:

### (i) Defining a Base Station Energy Consumption Model

Objective (i) is expected to include adapting frameworks of power consumption modelling and evaluation methodologies for UE power saving in NR (discussed in [5]) to the base station side. This is expected to involve adapting relative energy consumption for DL and UL (considering factors such as Power Amplifier (PA) efficiency, number of TXRU interfaces, base station load, etc), sleep states and associated transition times, and one or more reference parameters/configurations.

### (ii) Defining of an Evaluation Methodology and Key Performance Indicators (KPIs)

Objective (ii) is expected to include targeting the evaluation methodology for evaluating system-level network energy consumption and energy savings gains, as well as assessing/balancing impact to network and user performance (for example, spectral efficiency, capacity, User Perceived Throughput (UPT), latency, handover performance, call drop rate, initial access performance, Service Level Agreement (SLA) assurance related KPIs), energy efficiency, UE power consumption, and complexity. The evaluation methodology is expected to focus on reusing existing KPIs whenever applicable, rather than focusing on a single KPI. Where existing KPIs are found to be insufficient, new KPIs may be developed as needed. It has yet to be determined which KPIs will be evaluated and how.

(iii) Identifying Techniques on the gNB and UE Side to Improve Network Energy Savings in Terms of Both Base Station Transmission and Reception

Objective (iii) is expected to include achieving efficient operation dynamically and/or semi-statically and finer granularity adaptation of transmissions and/or receptions in one or more of network energy saving techniques in time, frequency, spatial, and power domains, with potential support/feedback from UE, and potential UE assistance information. Objective (iii) is also expected to include information exchange/coordination over network interfaces.

The study item is expected to prioritize idle/empty and low/medium load scenarios, with different loads among carriers and neighbour cells being permitted. The exact definition of such loads is expected to be determined as part of the study item.

The following examples of single-carrier and multi-carrier deployments are expected to be prioritized in the study item:
Urban micro in FRI, including Time Division Duplex (TDD) massive Multiple-Input Multiple-Output (MIMO). This can also model small cells.
FR2 beam-based scenarios (note: this scenario can also model small cells)
Urban/Rural macro in FRI with/without DSS Dynamic Spectrum Sharing (DSS). No impact to LTE expected in case of DSS.
Evolved-Universal Terrestrial Radio Access-New Radio Dual Connectivity (EN-DC)/New Radio Dual Connectivity (NR-DC) macro with Frequency Division Duplex (FDD) Primary Cell (PCell) and TDD/Massive MIMO on higher FR1/FR2 frequency

It intended that existing UEs will be able to continue accessing a network implementing Release-18 network energy savings techniques, with the possible exception of techniques developed specifically for greenfield deployments.

### Network Energy Saving (NES) Modes

It has been proposed that cells provided by infrastructure equipment of a wireless communications network are configured to operate in accordance with NES modes. Table 1 (reproduced from [6]) illustrates examples of proposed NES modes.

TABLE 1
Proposed NES modes.

| | | | Additional | Total |
|---|---|---|---|---|
| | | Relative | transition | transition |
| NES Mode | Characteristic | Power P | energy E | time T |
| Deep sleep | There is neither DL transmission nor UL reception. | P1 | E1 | T1 |
| | Time interval for the sleep is larger than the total | | | |
| | transition time entering and leaving this state. | | | |
| Light sleep | There is neither DL transmission nor UL reception. | P2 | E2 | T2 |
| | Time interval for the sleep is larger than the total | | | |
| | transition time entering and leaving this state. | | | |
| Micro sleep | There is neither DL transmission nor UL reception. | P3 | 0 | 0 |
| | Immediate transition is assumed for network energy | | | |
| | saving study purpose from or to a non-sleep state. | | | |
| Active DL | There is only DL transmission. | P4 | N/A | |
| Active UL | There is only UL reception. | P5 | | |

In Table 1, the transition time, T, for an NES mode is the time taken for a cell to enter or leave that NES mode. The additional transition energy, E, for an NES mode is the energy required for a cell to enter or leave that NES mode relative to a reference energy. The relative power, P, of an NES mode is the power consumed when a cell enters of leaves that NES mode relative to a reference power.

As will be understood by one skilled in the art, the relative power for the deep sleep NES mode is lower than the relative power for the light sleep NES mode which is lower than the relative power for micro sleep NES mode. In other words, P1<P2<P3. Furthermore, as will be understood by one skilled in the art, the relative power of the active UL NES mode has a lower relative power than the active DL NES mode. In other words, P5<P4.

Table 2 (reproduced from [6]) illustrates examples of relative power, P, values for the NES modes shown in Table 1 across different base station categories and reference configuration sets. Further detail on the base station categories and the reference configuration sets can be found in [6].

TABLE 2
Relative Power of Proposed NES modes.

| | BS Category 1 | | | BS Category 2 | | |
|---|---|---|---|---|---|---|
| NES Mode | Set 1 | Set 2 | Set 3 | Set 1 | Set 2 | Set 3 |
| Deep sleep | 1 | | | 1 | | |
| Light sleep | 25 | | | 2.1 | | |
| Micro sleep | 55 | 50 | 38 | 5.5 | 5 | 3 |
| Active DL | 280 | 200 | 152 | 32 | 26 | 17.6 |
| Active UL | 110 | 90 | 80 | 6.5 | 5.8 | 4.2 |

In addition to NES modes proposed in Table 1, other NES modes are envisaged. For example, a cell may be configured to operate in accordance with an NES mode which has a relative power lower than the deep sleep NES mode and requires a larger transition time. This may be referred to as a hibernating sleep, or Quasi-off, NES mode. Another example of an NES mode is an “OFF” NES mode where the cell is turned off for uplink and downlink data transmissions. As will be understood by one skilled in the art, a communications device in a cell in an OFF NES mode may still receive reference signals or send wakeup signal to wake up the cell.

Configuring network cells to operate in accordance with NES modes is expected to improve network energy savings. For example, in accordance with a network planning strategy, different cells in a wireless communications network may operate according to different NES modes. For example, a cell may be configured in a micro sleep NES mode when uplink/downlink traffic is expected imminently in the cell and another cell may be configured in a deep sleep NES mode when uplink/downlink traffic is not expected in the cell for considerable time.

### Adaptation of SDT Timer

As explained above, 3GPP has already specified small data transmission (SDT) in Rel-17 where a UE in RRC Inactive state (i.e., without transitioning to RRC_CONNECTED state) initiates the transmission of data provided that it is less than a predefined threshold (i.e., sdt-DataVolumeThreshold). This is known as mobile originated small data (MO-SDT). More description see Rel-17 TS 38.300 section 18 [1]. In addition, in Rel-18, there is ongoing work item (WI) for mobile terminated small data (MT-SDT) where a UE in RRC_Inactive state receives small data without transitioning to RRC_CONNECTED state [8].

Furthermore, in Rel-18, there is ongoing study item (SI) on network energy savings (NES) for NR [9]. One of the studied techniques is the gNB sleep mode configuration where gNB enters into sleep mode/state for a period of time along with the indication of active/inactive state, e.g., in terms of start time and duration in order to enable higher power saving gains at the gNB. This may include support of semi-static and/or dynamic gNB active/inactive adaptation.

As described above, the NES state refers to a state in which gNB goes to sleep and applies one or more network energy saving techniques, like cell DRX, DTX. A first issue to address is, when the cell is configured with NES state, how does the UE handle the transmission/reception of CG-SDT data in an RRC Inactive state?

A second issue to address is, if the timeAlignment timer expires for CG-SDT during a gNB sleep period, how should the UE handle the TimeAlignment timer as the CG resources are released? As will be appreciated by those familiar with CG-SDT, a timeAlignment is a time during which conditions for the UE to use configured grant resources are still valid in that the UE is unlikely to have moved and therefore will remain the time aligned with the wireless access interface and therefore the configured grant resources. This timeAlignment therefore is a time alignment which is timed by the UE and the network and when it expires the configured grant resources can no longer be used. As such, If the timer expires, then a UE cannot use an SDT procedure based on CG resource, because conditions for initiating SDT procedure are not fulfilled. This means the UE should go to an RRC Connected state which will increase a signalling overhead as well as power consumption at the UE.

A third issue to address is, if the SDT failure detection timer expires during a gNB sleep period while the UE has some SDT data remaining for transmission either via CG-SDT or RA-SDT, how should the UE handle the SDT failure detection timer? Otherwise, the UE will go to an RRC Idle state. As explained above, the SDT failure detection timer is only needed to be running during data transmissions, whilst the timeAlignment timer is required to be running as long as the UE is UL synchronised, regardless whether there is ongoing data transmission or not in order to validate CG resources.

Embodiments can provide a communications device (UE) or a method of transmitting data by a communications device (UE) via a wireless communications network, which comprises configuring transceiver circuitry of the communications device to transition to a Radio Resource Control (RRC) Inactive state, in which the communications device has established communications resources of a wireless access interface of the wireless communications network for transmitting or receiving data. The method further comprises receiving an indication of an Off-state of the infrastructure equipment as part of a DRX cycle. For example, the Off-state is a state in which transceiver circuitry is in a reduced power state and may not be able to receive signals transmitted by the communications device according to the DRX cycle, which includes an On-state in which the receiver of the infrastructure equipment is powered and can receive data from the communications device. The method comprises determining that the communications device has data to transmit to the infrastructure equipment, and transmitting the data to the infrastructure equipment in accordance with the received indication. The communications device may adapt the transmission by not transmitting the uplink data during the Off-state. The established communications resources may be configured grant resources.

According to example embodiments a UE that has an SDT data is allowed to skip CG PUSCH occasions that collide with gNB sleep duration (i.e., DRX OFF-duration) based on gNB indication to the UE(s) in advance in the NES cell. The UE then waits until gNB active duration comes back, i.e., the UE transmits SDT data on the gNB active duration (i.e., cell DRX ON-duration).

The gNB could signal a (long) Cell DRX cycle for all UL signals and channels where all UEs in the NES cell are informed, that the cell is entering into sleep mode, for example via Paging message (e.g., 1-bit), or when a UE is moved to Inactive state i.e., RRC Release with suspend config containing when NES state DRX cycle will start and or its periodic configuration.

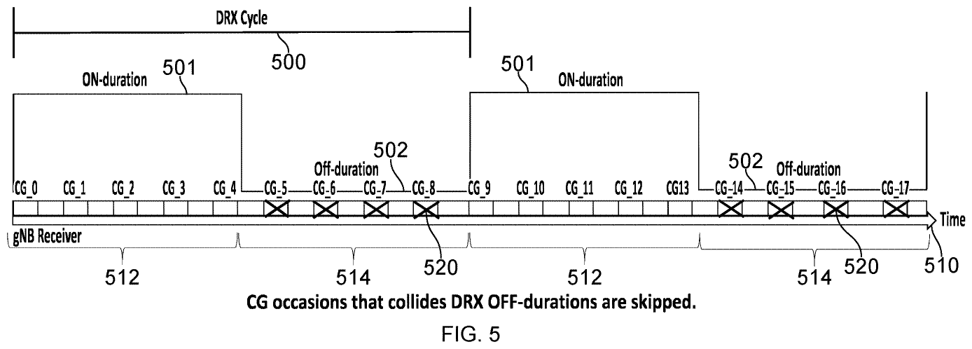

FIG. 5 provides an illustrative representation of a DRX duty cycle performed by a gNB 341 forming part of a wireless access network configured with an NES mode. As shown on FIG. 5, the long Cell DRX cycle is periodic. As shown in FIG. 5, the duty cycle 500 includes an On-state 501 and an Off-state 502. The UE can only transmit UL signals and channels on the CG occasions in the ON-duration period. So, when a CG occasion collides with “OFF-duration”, the UE should skip this CG occasion and postpones the data transmission to the next earliest available CG occasion in the DRX ON-duration. During the On-state, the transmitter and receiver of the gNB 341 is powered up so that these can respectively transmit and receive or detect signals to or from communications devices within a cell formed by the gNB 341. As shown in FIG. 5 a timeline 510, includes a plurality of sets of configured grant resources, numbered CG_0 to CG_17.

According to the above explanation, the gNB 341 configures the UE 301 to transmit or to receive signals in configured grant (CG) resources forming part of a wireless access interface formed by the gNB 341. As shown, the CG resources fall respectively within on durations 501 and off durations 502. As will be appreciated for example when the receiver of the gNB is in an On-state, it is able to receive uplink data, so that the UE can transmit uplink data in the configured grant resources 512 falling within the On-state 501. CG resources 514 falling within the Off-state 502 cannot be used to transmit uplink data, as represented by crosses 520 over the CG resources affected 520. Embodiments of the present technique therefore adapt the transmission of the uplink data in accordance with the duty cycle 500 of the gNB 341, as will be explained with the following examples. For example, CG_5 to CG_8 collide with DRX Off-duration, hence, a UE skips these occasions and transmit SDT data on occasions starting at CG_9. Similarly, the UE skips CG_14 to CG_17 and transmit SDT data on later occasions.

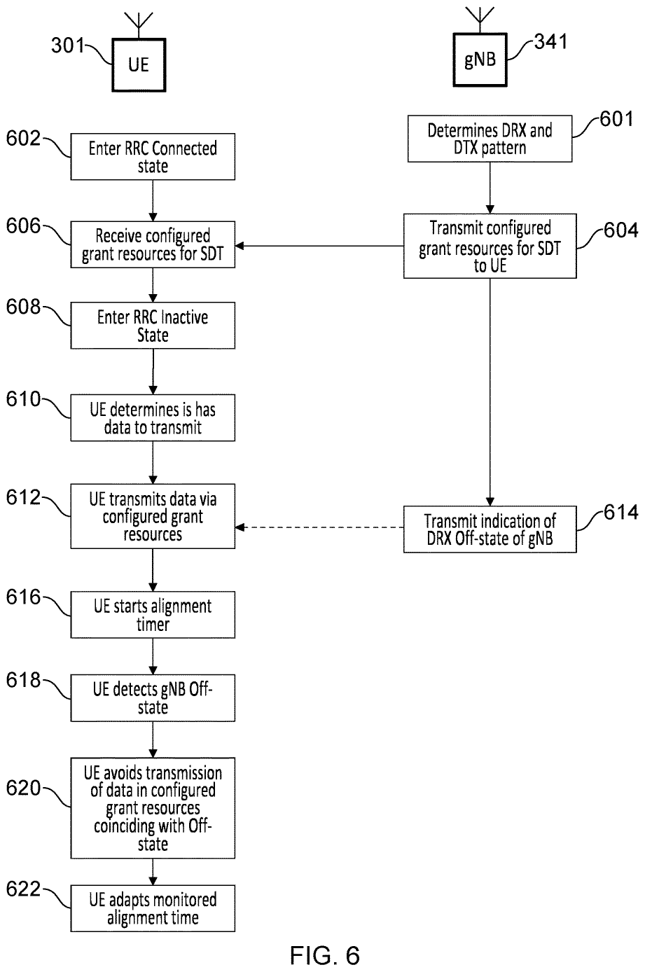

An illustrative representation of an example embodiment presented in FIG. 6 provides a flow diagram illustrating operations performed by the UE 301 and the gNB be 341 in order to transmit data for example small amounts of data (SDT) using configured grant resources (CG). As shown in FIG. 6 at some point either during the process steps that are shown in FIG. 6 the gNB 341 determines its DRX cycle 500 including an Off-state 502 and On-state 502 as illustrated in FIG. 5. As a first step 601 therefore, the gNB 341 determines the DRX and DTX patterns including the Off-state 502 and the On-state 501.

On the UE side, at some point the UE 301 enters an RRC Connected state 602 in which it establishes a data bearer via the gNB 341 and across the network in order to set up physical later, radio link layer and media access layer protocols for the transmission and reception of data. Thus the UE 301 establishes a context with the wireless communications network via the gNB 341. According to this example, at step 604 the gNB 341 transmits control information in order to configure the UE 301 with configured grant resources for the transmission by the UE 341 of data on the uplink which may be consistent with and according to a small data transmission (SDT) protocol. Thus in step 606 the UE configures its transmitter and receiver to transmit data on demand in the CG resources CG0 to CG17. That is to say, the CG resources are available to the UE for small data transmissions whether or not the UE actually has data to transmit. Having configured the transmitter to use the CG resources, the UE 301 then returns to an RRC_Inactive state in which it suspends protocols associated with transmitting via a data bearer setup using or during the RRC Connected state.

There then enters a phase in which the UE 301 determines that it has data to transmit on the uplink to the gNB 341 which may be an SDT transmission. At step 610 the UE determines that it has data to transmit on the uplink and at step 612 the UE transmits the data via the CG resources.

At some point during the flow representing the processes performed in FIG. 6, the gNB 341 transmits an indication to the UE 301 of the DRX Off-state 502 and therefore indicates a period during which the UE 301 is not able to use those CG resources 514. As explained above, there are various options for informing the UE 301 of the DRX cycle 500. In one example the DRX cycle 500 is communicated to the UE when in the RRC Connected state 602. In another example, the gNB 341 transmits the indication of the DRX Off-state just before the gNB 341 enters the Off-state 502. Thus as shown in FIG. 6 generally at step 614 the gNB 341 transmits an indication of the DRX Off-state of the gNB 341 to the UE 301 so that the UE is aware of the CG resources which it cannot use as represented by a cross 520.

The transmission of the uplink data in the CG resources by the UE 31 is therefore adapted in accordance with the DRX cycle 500. In one example when the UE begins to transmit the uplink data via the CG resources which can be used 512, the UE starts an alignment timer as shown in step 616. In accordance with the information received from the gNB 341 in step 614, the UE detects that the gNB is in an Off-state 502 in step 618 and in step 620 avoids transmitting uplink data in those CG resources which coincide with the Off-state 514. Furthermore, according to the example shown in FIG. 6, the UE adapts the monitored alignment timer to compensate or include any off duration 502 of the gNB 341. For example, to avoid the alignment timer expiring during a DRX Off-state 502. In one example, the alignment timer is extended during an Off-state 502 until the gNB is once again in an On-state. According to example embodiments therefore, during a DRX OFF period 502, the time alignment timer may expire. In that case, the UE should extend the time alignment timer based on the amount of the OFF-duration time 502. For example, if the OFF-duration time is 40 ms, then the UE adds this time to the time alignment timer so that it does not expire in the middle of the DRX OFF-duration.

In another embodiment, during DRX OFF period, if the time alignment timer is about to expire, the UE restarts the time alignment timer autonomously.

In another embodiment, before entering DRX OFF period, a gNB sends a command to update the time alignment timer at the UE.

Embodiments can also provide a communications device (UE) or a method of transmitting or receiving data by a communications device (UE) via a wireless communications network, which comprises configuring transceiver circuitry of the communications device to transition to a Radio Resource Control (RRC) Inactive state, in which the communications device has established communication with an infrastructure equipment of the wireless medications network for transmitting or receiving data. The method further comprises receiving an indication of an Off-state of a discontinuous reception (DRX) cycle of the infrastructure equipment. The Off-state may be a state in which a receiver of the infrastructure equipment is in a reduced power state according to the DRX cycle, which includes an On-state in which the receiver of the infrastructure equipment is powered and can receive data from the communications device. The method comprises transmitting a random access preamble to an infrastructure equipment of the wireless communications network as part of a random access procedure for transmitting data to the wireless communications network, receiving a message from the infrastructure equipment in response to the random access preamble as part of the random access procedure, and transmitting data to the infrastructure equipment as part of or after completing the random access procedure. The method further comprises starting a failure detection timer for detecting whether the transmission of the data to the infrastructure equipment has been completed within a transmission failure time, determining that the communications device has failed to transmit the data to the infrastructure equipment if the failure detection timer exceeds the transmission failure time, and adapting the transmission of the data in accordance with the received indication of the Off-state. The communications device may adapt the transmission by not transmitting the uplink data during the Off-state and/or the transmission failure timer in accordance with a duration of the Off-state.

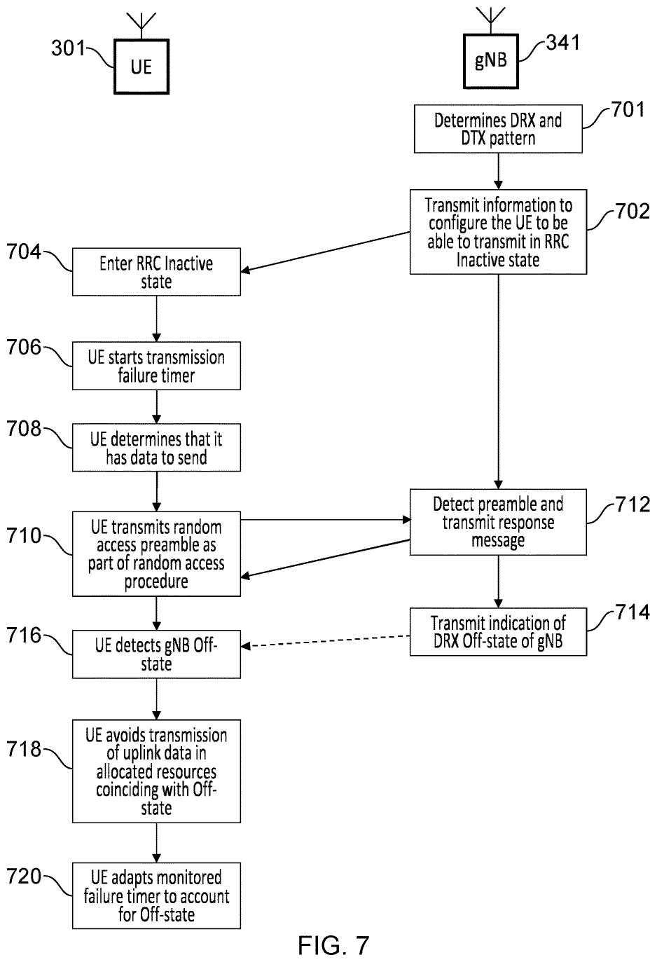

Another example embodiment is shown in FIG. 7 in which SDT uplink transmission occurs using a random access procedure. As shown in FIG. 7 in common with the step 601 in FIG. 6, at step 701 the gNB 341 determines its DRX cycle 500 including an On-state 510 and an Off-state 512 as represented in FIG. 5. In FIG. 7, the gNB 341 then transmits signalling/control information to allow the UE 301 to transmit data on the uplink using a random access procedure in an RRC_Inactive state.

At some point, the UE 301 enters an RRC_Inactive state 704 in which it has been configured with parameters for its transmitter and receiver to transmit data without having to re-establish a bearer across the wireless communications network. Thus, the UE can transmit data on demand in accordance with requirements of services supported by the UE, provided communication parameters established during an RRC Connected state are still valid, such as a synchronisation with the gNB 341. In order to ensure that the communications parameters for example synchronisation still valid, the UE starts a transmission failure timer at step 706. At step 708, the UE determines that it has data to transmit on the uplink. At step 710 the UE performs a random access procedure to transmit the uplink data, including transmitting a random access preamble. At step 712 the gNB 341 detects the preamble and transmits a response message to the UE 301. The response message can be either message 3 or message B in accordance with whether the random access procedure is a 4-step RACH or a 2-step RACH.

According to example embodiments, the UE at step 706 has started a transmission failure timer for transmitting the uplink data according to the service being supported. In other example embodiments, the transmission failure timer is started when the UE in the starts the random access procedure or transmits data as part of the random access procedure or after the random access procedure uplink data is first transmitted. Depending on the amount of data to be transmitted, the UE may transmit all this data during the random access procedure which may be a 2 step or 4-step RACH. However, if not all of the data is transmitted during the random access procedure, then the UE uses a transmission failure timer to monitor a transmission failure time. After the transmission failure time has expired, then it is considered that the attempt to transmit the uplink data has failed because for example the UE may have moved and therefore the assumed transmission parameters required for RRC_Inactive state are no longer valid.

At some point during the processes shown in FIG. 7, the gNB 341 at step 714 transmits to the UE 301 an indication of a DRX Off-state 512 of the gNB 341 in which it cannot receive data on the uplink. As explained with reference to the example of FIG. 6, communication of the DRX off-state may be achieved by transmitting, in advance of any SDT, an indication of the DRX cycle. In other examples the gNB 341 may transmit a message such as a paging message when it is about to enter a DRX Off-state. The transmission of the indication of the DRX Off-state in step 714 may occur at any point in the procedure before for example step 710 when the UE begins the random access procedure.

The UE detects the gNB Off-state in step 716, although as will be appreciated step 716 may be a determination by the UE that an off state of the gNB is about to occur based on previous indication of a DRX cycle of the gNB. At step 718 the UE transmits the uplink data in the DRX On-state 501 but suspends or stops transmission of the uplink data during the DRX Off-state 502. Furthermore, in accordance with example embodiments, in step 720 the UE adapts the monitored failure timer to account for the Off-state 502 by either extending the monitored failure time by an amount equivalent to the Off-state or extending the timer until the DRX On-state 501. For example, the transmission failure timer may be counting down from a transmission failure time. Therefore, adding an amount of time equivalent to the DRX off-state 502 to the current state of the transmission failure timer or stopping the transmission failure timer for a period of the DRX off-state will have the effect of extending the transmission failure time.

Effectively therefore, during DRX OFF period, the UE 301 detects that the SDT failure detection timer may expire. In that case, the UE should extend the SDT failure detection timer based on the amount of the OFF-duration time. This will prevent the UE going into the RRC Idle state. In this case, if the timer is extended, the UE can transmit the remaining SDT data in the next DRX ON period.

In another embodiment, if the SDT failure detection timer expires during the gNB sleep duration (i.e., DRX OFF-duration), the UE goes into the RRC Idle state.

In another embodiment, before entering DRX OFF period, gNB sends a command to extend the SDT failure detection timer at the UE. Alternatively, in another embodiment, SDT failure detection timer is stopped/paused during the duration when NES state of a cell is OFF and UE is not performing any transmission and/or reception and then the timer is restarted without resetting the timer value (i.e., continue with the value before the NES state was OFF).

As will be appreciated from the above explanation, embodiments can also include an infrastructure equipment and a method of receiving data from a communications device by an infrastructure forming part of a wireless communications network. The method comprises configuring a communications device to transition to an Radio Resource Control, RRC, Inactive state, in which the communications device is configured with a grant of resources for the communications device to transmit uplink data to the infrastructure equipment, transmitting an indication of an Off-state in which a receiver of the infrastructure equipment is in a reduced power state and cannot receive signals transmitted by the communications device according to a discontinuous reception, DRX, cycle, which includes an ON-state in which the receiver of the infrastructure equipment is powered and can receive data from the communications device. The configuring the communications device to transmit the uplink data includes configuring the communications device to transmit the uplink data during the On-state and to suspend transmission of the uplink data during the Off-state.

It will be appreciated that while the present disclosure has in some respects focused on implementations in 5G networks for the sake of providing specific examples, the same principles can be applied to other wireless telecommunications systems. Thus, even though the terminology used herein is generally the same or similar to that of the 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known by both the base station and the communications device. It will be appreciated such predetermined/predefined information may in general be established, for example, by definition in an operating standard for the wireless telecommunication system, or in previously exchanged signalling between the base station and communications devices, for example in system information signalling, or in association with radio resource control setup signalling, or in information stored in a SIM application. That is to say, the specific manner in which the relevant predefined information is established and shared between the various elements of the wireless telecommunications system is not of primary significance to the principles of operation described herein. It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:

Paragraph 1. A method of transmitting or receiving data by a communications device via a wireless communications network, the method comprising
configuring transceiver circuitry of the communications device to transition to a Radio Resource Control, RRC, Inactive state, in which the communications device has established communications resources of a wireless access interface provided by the wireless communications network for transmitting or receiving data,
receiving an indication of an Off-state of a discontinuous reception, DRX, cycle of an infrastructure equipment of the wireless communications network,
determining that the communications device has data to transmit to the infrastructure equipment, and
transmitting the data to the infrastructure equipment in accordance with the received indication.

Paragraph 2. A method of paragraph 1, wherein the transmitting is adapted according to the DRX cycle of the infrastructure equipment.

Paragraph 3. A method of paragraph 2, wherein the transmitting the data is adapted by suspending transmission of the data during the Off-state of the DRX cycle of the infrastructure equipment.

Paragraph 4. A method of paragraph 1 or 2, wherein the receiving the indication of the Off-state comprises receiving an indication when the infrastructure equipment will enter the Off-state in which the receiver of the infrastructure equipment cannot receive signals transmitted by the communications device and when the infrastructure will enter an On-state in which the receiver of the infrastructure equipment is powered and can receive data from the communications device.

Paragraph 5. A method of any of paragraphs 1 to 4, wherein the receiving the indication of the Off-state comprises receiving a signalling message transmitted by the infrastructure equipment that the infrastructure equipment will enter an Off-state.

Paragraph 6. A method of paragraph 5, wherein the signalling message is received as a paging message.

Paragraph 7. A method of paragraph 5, wherein the signalling message is received as an RRC suspend message.

Paragraph 8. A method of any of paragraphs 1 to 7, wherein the configuring transceiver circuitry of the communications device to transition to a Radio Resource Control, RRC, Inactive state comprises
receiving configuration information providing configured grant resource for the communications device to transmit uplink data to the infrastructure equipment on communications resources of the wireless access interface provided by the infrastructure equipment, the configured grant resources comprising a plurality of configured grant occasions for transmitting uplink data in the RRC_Inactive state which can be used by the communications device to transmit uplink data, the configured grant resources being the established resources for use in the RRC_Inactive state, and the transmitting the uplink data to the infrastructure equipment comprises
determining that one or more configured grant occasions are during the DRX Off-state of the DRX cycle of the infrastructure equipment, and
delaying transmission of the uplink data which would have been transmitted in the one or more configured grant occasions during the DRX Off-state of the infrastructure equipment and transmitting the delayed uplink data in one or more configured grant occasions which are within the DRX On-state.

Paragraph 9. A method of paragraph 8, wherein the configuration information includes a time alignment for which the communications device is considered to be synchronised with the infrastructure equipment for transmitting the uplink data using the configured grant resource,
starting an alignment timer when the communications device enters the RRC_Inactive state,
detecting that the alignment timer has reached the alignment time during the DRX Off-state of the infrastructure equipment, and
extending the time alignment timer until the DRX On-state of the infrastructure equipment.

Paragraph 10. A method of paragraph 8, wherein the configuration information includes a time alignment for which the communications device is considered to be synchronised with the infrastructure equipment for transmitting the uplink data using the configured grant resource,
starting an alignment timer when the communications device enters the RRC_Inactive state,
detecting that the alignment timer has reached the alignment time during the DRX Off-state of the infrastructure equipment, and
restarting the time alignment timer.

Paragraph 11. A method of paragraph 8, wherein the configuration information includes a time alignment for which the communications device is considered to be synchronised with the infrastructure equipment for transmitting the uplink data using the configured grant resource,
starting an alignment timer when the communications device enters the RRC_Inactive state, and
receiving a command from the infrastructure equipment before the DRX Off-state of the infrastructure equipment to extend the alignment timer, and
extending the time alignment timer until the DRX On-state of the infrastructure equipment.

Paragraph 12. A method of paragraph 8, wherein the configuration information includes a time alignment for which the communications device is considered to be synchronised with the infrastructure equipment for transmitting the uplink data using the configured grant resource,
starting an alignment timer when the communications device enters the RRC_Inactive state, and
receiving a command from the infrastructure equipment before the DRX Off-state of the infrastructure equipment to restart the time alignment timer, and
restarting the time alignment timer.

Paragraph 13. A method of any of paragraphs 1 to 12, wherein the Off-state of the infrastructure equipment comprises a state in which a receiver of the infrastructure equipment is a reduced power state and cannot receive signals transmitted by the communications device according to a discontinuous reception, DRX, cycle, which includes an ON-state in which the receiver of the infrastructure equipment is powered and can receive data from the communications device.

Paragraph 14. A method of transmitting data by a communications device via a wireless communications network, the method comprising
configuring transceiver circuitry of the communications device to transition to a Radio Resource Control, RRC, Inactive state, in which the communications device can transmit via a wireless access interface provided by the wireless communications network,
receiving an indication of an Off-state of a discontinuous reception, DRX, cycle of an infrastructure equipment of the wireless communications network,
transmitting a random access preamble to an infrastructure equipment of the wireless communications network as part of a random access procedure for transmitting data to the wireless communications network,
receiving a message from the infrastructure equipment in response to the random access preamble as part of the random access procedure,
transmitting data to the infrastructure equipment as part of or after completing the random access procedure,
starting a failure detection timer for detecting whether the transmission of the data to the infrastructure equipment has been completed within a transmission failure time, and
adapting the transmission of the data in accordance with the received indication of the Off-state.

Paragraph 15. A method of paragraph 14, wherein the adapting the transmission of the data in accordance with the received indication comprises
extending the transmission failure time in accordance with the Off-state.

Paragraph 16. A method of paragraph 14, wherein the adapting the transmission of the data in accordance with the received indication comprises stopping the failure detection timer for the duration of the Off-state.

Paragraph 17. A method of any of paragraphs 14, 15 or 16, wherein the indication of the Off-state is received at a time contemporaneous with the start of the Off-state.

Paragraph 18. A method of any of paragraphs 14 to 17, wherein the indication of the Off-state is sent as a paging message.

Paragraph 19. A method of any of paragraphs 14 to 17, wherein the signalling message is received as an RRC suspend message.

Paragraph 20. A method of any of paragraphs 14 to 19, comprising
configuring transceiver circuitry of the communications device to transition to a Radio Resource Control, RRC, Idle state, in which the communications device no longer has an active connection for transmitting or receiving data via the wireless communications network, when the failure detection timer expires.

Paragraph 21. A method of any of paragraphs 14 to 20, wherein the Off-state of the infrastructure equipment comprises a state in which a receiver of the infrastructure equipment is a reduced power state and cannot receive signals transmitted by the communications device according to a discontinuous reception, DRX, cycle, which includes an ON-state in which the receiver of the infrastructure equipment is powered and can receive data from the communications device.

Paragraph 22. A method of receiving data from a communications device by an infrastructure forming part of a wireless communications network, the method comprising
configuring a communications device to transition to an Radio Resource Control, RRC, Inactive state, in which the communications device is configured with a grant of resources for the communications device to transmit uplink data to the infrastructure equipment,
transmitting an indication of an Off-state of a discontinuous reception, DRX, cycle of the infrastructure equipment of the wireless communications network, wherein the configuring the communications device to transmit the uplink data includes
configuring the communications device to transmit the uplink data during the On-state and to suspend transmission of the uplink data during the Off-state.

Paragraph 23. A method of paragraph 22, wherein the configuring the communications device to transmit the uplink data during the On-state and to suspend transmission of the uplink data during the Off-state comprises
determining a packet delay budget for transmitting one or more packets of the uplink data,
determining a delay in transmitting one of the one or more packets in the On-state including any delay caused by suspending a transmission of the packet as a result of the Off-state, and either
transmitting the packet during the On-state when the delay is within the packet delay budget, or
dropping transmission of the packet when the packet delay budget is exceeded.

Paragraph 24. A method of paragraph 22 or 23, comprising
transmitting a paging message to the communications device, when the infrastructure equipment is about to enter the Off-state.

Paragraph 25. A method of any of paragraphs 22, 23 or 24, comprising
performing a Time Alignment Timer, TAT, maintenance procedure before entering a DTX Off-state, if a TAT timer will expire during the Off-state.

Paragraph 26. A method of any of paragraphs 22 to 25, comprising
receiving a random access preamble from a communications device as part of a random access procedure for receiving data,
transmitting a message to the communications device in response to the random access preamble as part of the random access procedure,
receiving data from the communications device as part of or after completing the random access procedure, and
transmitting a command to the communications device to extend a failure detection timer for detecting whether the transmission of the data to the infrastructure equipment has been completed within a transmission failure time, if the failure detection timer will expire during the Off-state.

Paragraph 27. A method of any of paragraphs 22 to 26, wherein the Off-state of the infrastructure equipment comprises a state in which a receiver of the infrastructure equipment is a reduced power state and cannot receive signals transmitted by the communications device according to the DRX cycle, which includes an ON-state in which the receiver of the infrastructure equipment is powered and can receive data from the communications device.

Paragraph 28. A method of any of paragraphs 22 to 27, comprising
receiving a network energy saving configuration information identifying a sleep state of the infrastructure equipment, and
during the sleep state suspending the configuring the communications devices and other RRC procedures, and the transmitting the indication of the Off-state of the DRX cycle.

Paragraph 29. A communications device configured to transmit data via a wireless communications network, the communications device comprising
transceiver circuitry configured to transmit signals to or to receive signals from an infrastructure equipment via a wireless access interface provided by the wireless communications network, and
controller circuitry configured to control the transceiver circuitry
to transition to a Radio Resource Control, RRC, Inactive state, in which the transceiver circuitry has established communications resources of the wireless access interface for transmitting or receiving signals representing data,
to receive an indication of an Off-state of a discontinuous reception, DRX, cycle of the infrastructure equipment,
to determine that the communications device has data to transmit to the infrastructure equipment, and
to transmit the data to the infrastructure equipment in accordance with the received indication of the Off-state.

Paragraph 30. A communications device of paragraph 29, wherein the transmitting is adapted according to the DRX cycle of the infrastructure equipment.

Paragraph 31. A communications device of paragraph 30, wherein the transmitting the data is adapted by suspending transmission of the data during the Off-state of the DRX cycle of the infrastructure equipment.

Paragraph 32. A communications device of paragraph 29, 30 or 31, wherein the receiving the indication of the Off-state comprises receiving an indication when the infrastructure equipment will enter the Off-state in which the receiver of the infrastructure equipment cannot receive signals transmitted by the communications device and when the infrastructure will enter an On-state in which the receiver of the infrastructure equipment is powered and can receive data from the communications device.

Paragraph 33. A communications device of any of paragraphs 29 to 32, wherein the receiving the indication of the Off-state comprises receiving a signalling message transmitted by the infrastructure equipment that the infrastructure equipment will enter an Off-state.

Paragraph 34. A communications device configured to transmit data via a wireless communications network, the communications device comprising
transceiver circuitry configured to transmit signals to or to receive signals from an infrastructure equipment via a wireless access interface provided by the wireless communications network, and
controller circuitry configured to control the transceiver circuitry
to receive an indication of an Off-state of a discontinuous reception, DRX, cycle of an infrastructure equipment of the wireless communications network,
to transmit a random access preamble to an infrastructure equipment of the wireless communications network as part of a random access procedure for transmitting data to the wireless communications network,
to receive a message from the infrastructure equipment in response to the random access preamble as part of the random access procedure,
to transmit data to the infrastructure equipment as part of or after completing the random access procedure,
to start a failure detection timer for detecting whether the transmission of the data to the infrastructure equipment has been completed within a transmission failure time, and
to adapt the transmission of the data in accordance with the received indication of the Off-state.

Paragraph 35. A communications device of paragraph 34, wherein the adapting the transmission of the data in accordance with the received indication comprises extending the transmission failure time in accordance with the Off-state.

Paragraph 36. A communications device of paragraph 34, wherein the adapting the transmission of the data in accordance with the received indication comprises stopping the failure detection timer for the duration of the Off-state.

Paragraph 37. A communications device of any of paragraphs 34, 35 or 36, wherein the indication of the Off-state is received at a time contemporaneous with the start of the Off-state.

Paragraph 38. An infrastructure equipment for forming part of a wireless communications network, the infrastructure equipment comprising
transceiver circuitry configured to transmit signals to or to receive signals from communications devices via a wireless access interface provided by the infrastructure equipment, and
controller circuitry configured to control the transceiver circuitry
to configure a communications device to transition to an Radio Resource Control, RRC, Inactive state, in which the communications device is configured with a grant of resources for the communications device to transmit uplink data to the infrastructure equipment,
to transmit an indication of an Off-state of a discontinuous reception, DRX, cycle of the infrastructure equipment of the wireless communications network, wherein the communications device is configured to transmit the uplink data during the On-state and to suspend transmission of the uplink data during the Off-state.

Paragraph 39. An infrastructure equipment of paragraph 38, wherein the configuring the communications device to transmit the uplink data during the On-state and to suspend transmission of the uplink data during the Off-state comprises
determining a packet delay budget for transmitting one or more packets of the uplink data,
determining a delay in transmitting one of the one or more packets in the On-state including any delay caused by suspending a transmission of the packet as a result of the Off-state, and either
transmitting the packet during the On-state when the delay is within the packet delay budget, or
dropping transmission of the packet when the packet delay budget is exceeded.

Paragraph 40. An infrastructure equipment of paragraph 38 or 39, comprising transmitting a paging message to the communications device, when the infrastructure equipment is about to enter the Off-state.

Paragraph 41. An infrastructure equipment of any of paragraphs 38, 39 or 40, comprising
performing a Time Alignment Timer, TAT, maintenance procedure before entering a DTX Off-state, if a TAT timer will expire during the Off-state.

Paragraph 42. An infrastructure equipment of any of paragraphs 38 to 41, comprising
receiving a random access preamble from a communications device as part of a random access procedure for receiving data,
transmitting a message to the communications device in response to the random access preamble as part of the random access procedure,
receiving data from the communications device as part of or after completing the random access procedure, and
transmitting a command to the communications device to extend a failure detection timer for detecting whether the transmission of the data to the infrastructure equipment has been completed within a transmission failure time, if the failure detection timer will expire during the Off-state.

Paragraph 43. A non-transitory computer-readable storage medium storing a computer program which when executed by a processor performs the method according to any of paragraphs 1 to 28.

### REFERENCES

[1] RP-182090, “Revised SID: Study on NR Industrial Internet of Things (IoT),” 3GPP RAN #81.
[2] Holma H. and Toskala A, “LTE for UMTS OFDMA and SC-FDMA based radio access”, John Wiley and Sons, 2009.
[3] TS38.300 V16.5.0, “NG and NR-RAN Overall Description”, Release 16.
[4] RP-213554, “Study on network energy savings for NR”.
[5] TR38.840, “Study on User Equipment (UE) power saving in NR”, Release 16.
[6] TR38.864, “Study on network energy savings for NR”, Release 18.
[7] R2-2213040, “Post RAN2 #120 TP for TR 38.864”, Release 18.
[8] TS 38.300 V17.2.0, section 18.
[9] RP-212726, “WID: New WID on MT-SDT”.
[10] RP-220297, “Revised SI: Study on network energy savings for NR”.

1.-28. (canceled)

29. A communications device configured to transmit data via a wireless communications network, the communications device comprising
transceiver circuitry configured to transmit signals to or to receive signals from an infrastructure equipment via a wireless access interface provided by the wireless communications network, and
controller circuitry configured to control the transceiver circuitry
to transition to a Radio Resource Control, RRC, Inactive state, in which the transceiver circuitry has established communications resources of the wireless access interface for transmitting or receiving signals representing data,
to receive an indication of an Off-state of a discontinuous reception, DRX, cycle of the infrastructure equipment,
to determine that the communications device has data to transmit to the infrastructure equipment, and
to transmit the data to the infrastructure equipment in accordance with the received indication of the Off-state.

30. A communications device of claim 29, wherein the transmitting is adapted according to the DRX cycle of the infrastructure equipment.

31. A communications device of claim 30, wherein the transmitting the data is adapted by suspending transmission of the data during the Off-state of the DRX cycle of the infrastructure equipment.

32. A communications device of claim 29, wherein the receiving the indication of the Off-state comprises receiving an indication when the infrastructure equipment will enter the Off-state in which the receiver of the infrastructure equipment cannot receive signals transmitted by the communications device and when the infrastructure will enter an On-state in which the receiver of the infrastructure equipment is powered and can receive data from the communications device.

33. A communications device of claim 29, wherein the receiving the indication of the Off-state comprises receiving a signalling message transmitted by the infrastructure equipment that the infrastructure equipment will enter an Off-state.

34. A communications device configured to transmit data via a wireless communications network, the communications device comprising
transceiver circuitry configured to transmit signals to or to receive signals from an infrastructure equipment via a wireless access interface provided by the wireless communications network, and
controller circuitry configured to control the transceiver circuitry
to receive an indication of an Off-state of a discontinuous reception, DRX, cycle of an infrastructure equipment of the wireless communications network,
to transmit a random access preamble to an infrastructure equipment of the wireless communications network as part of a random access procedure for transmitting data to the wireless communications network,
to receive a message from the infrastructure equipment in response to the random access preamble as part of the random access procedure,
to transmit data to the infrastructure equipment as part of or after completing the random access procedure,
to start a failure detection timer for detecting whether the transmission of the data to the infrastructure equipment has been completed within a transmission failure time, and
to adapt the transmission of the data in accordance with the received indication of the Off-state.

35. A communications device of claim 34, wherein the adapting the transmission of the data in accordance with the received indication comprises
extending the transmission failure time in accordance with the Off-state.

36. A communications device of claim 34, wherein the adapting the transmission of the data in accordance with the received indication comprises stopping the failure detection timer for the duration of the Off-state.

37. A communications device of claim 34, wherein the indication of the Off-state is received at a time contemporaneous with the start of the Off-state.

38. An infrastructure equipment for forming part of a wireless communications network, the infrastructure equipment comprising
transceiver circuitry configured to transmit signals to or to receive signals from communications devices via a wireless access interface provided by the infrastructure equipment, and
controller circuitry configured to control the transceiver circuitry
to configure a communications device to transition to an Radio Resource Control, RRC, Inactive state, in which the communications device is configured with a grant of resources for the communications device to transmit uplink data to the infrastructure equipment,
to transmit an indication of an Off-state of a discontinuous reception, DRX, cycle of the infrastructure equipment of the wireless communications network, wherein the communications device is configured to transmit the uplink data during the On-state and to suspend transmission of the uplink data during the Off-state.

39. An infrastructure equipment of claim 38, wherein the configuring the communications device to transmit the uplink data during the On-state and to suspend transmission of the uplink data during the Off-state comprises
determining a packet delay budget for transmitting one or more packets of the uplink data,
determining a delay in transmitting one of the one or more packets in the On-state including any delay caused by suspending a transmission of the packet as a result of the Off-state, and either
transmitting the packet during the On-state when the delay is within the packet delay budget, or
dropping transmission of the packet when the packet delay budget is exceeded.

40. An infrastructure equipment of claim 38, comprising
transmitting a paging message to the communications device, when the infrastructure equipment is about to enter the Off-state.

41. An infrastructure equipment of claim 38, comprising
performing a Time Alignment Timer, TAT, maintenance procedure before entering a DTX Off-state, if a TAT timer will expire during the Off-state.

42. An infrastructure equipment of claim 38, comprising
receiving a random access preamble from a communications device as part of a random access procedure for receiving data,
transmitting a message to the communications device in response to the random access preamble as part of the random access procedure,
receiving data from the communications device as part of or after completing the random access procedure, and
transmitting a command to the communications device to extend a failure detection timer for detecting whether the transmission of the data to the infrastructure equipment has been completed within a transmission failure time, if the failure detection timer will expire during the Off-state.

43. (canceled)
